(19) United States
(12) Patent Application Publication
(10) Pub. No.: US 2010/0064305 A1
(43) Pub. Date: Mar. 11, 2010

(54) SYSTEM AND METHOD OF DETECTING UNAUTHORIZED CONTENT USAGE

(75) Inventors: Robert Schumann, Oakton, VA (US); Michael Bergeron, Richmond, VA (US); Guillaume Mercier, Jouy-En-Josas (FR); Bin Zhao, Mayfield Heights, OH (US)

Correspondence Address: Dolby Laboratories Inc., 100 Potrero Avenue, San Francisco, CA, 94103-4938, US

(73) Assignee: DOLBY LABORATORIES LICENSING CORPORATION, San Francisco, CA (US)

(21) Appl. No.: 12/556,775

(22) Filed: Sep. 10, 2009

Related U.S. Application Data
(60) Provisional application No. 61/095,913, filed on Sep. 10, 2008.

(51) Int. Cl. H04N 7/16; H04N 7/167

(52) U.S. Cl. 725/19; 382/100; 725/31

(57) ABSTRACT

In one embodiment the present invention includes a system for identifying an unauthorized display of content. The system includes a preprocessor, an inserter, an observation device, and a subscriber information device. The preprocessor device preprocesses the content for subsequent insertion of semi-visible information. The inserter device inserts a semi-visible watermark into the content as having been preprocessed by the preprocessor device. The semi-visible watermark corresponds to a subscriber identifier. The observation device executes processing, including receiving an input from an observer that observes a display of the content that includes the semi-visible watermark. The input corresponds to the semi visible watermark. The processing further includes processing the input to generate an input result. The subscriber information device stores subscriber identifiers and identifies a particular subscriber by comparing the input result and the subscriber identifiers.

### CROSS REFERENCE TO RELATED APPLICATIONS

This application claims priority to U.S. Provisional Patent Application No. 61/095,913, filed 10 Sep. 2008, hereby incorporated by reference in its entirety.

### BACKGROUND

The present invention relates to detecting unauthorized content display, and in particular, to detecting unauthorized content display using discreet watermarks.

Unless otherwise indicated herein, the approaches described in this section are not prior art to the claims in this application and are not admitted to be prior art by inclusion in this section.

Piracy of content, especially of television or other audiovisual programming, is a continuing issue. As one example, European satellite broadcasters sell special commercial licenses to businesses (e.g., pubs/bars) to display sports packages (e.g., soccer matches). The same content is sold to non-commercial users at a lower price. To save money, some pubs use the non-commercial product in a commercial environment.

As another example, in India, pirating of cable signals is a problem. For example, someone in an apartment building may receive a legal cable signal and then rebroadcast it to the rest of the building.

### SUMMARY

Embodiments of the present invention improve the ability to identify unauthorized content displays. According to an embodiment, a system identifies an unauthorized display of content. The system includes a preprocessor, an inserter, an observation device, and a subscriber information device. The preprocessor device preprocesses the content for subsequent insertion of semi-visible information. The inserter device inserts a semi-visible watermark into the content as having been preprocessed by the preprocessor device. The semi-visible watermark corresponds to a subscriber identifier. The observation device executes processing, including receiving an input from an observer that observes a display of the content that includes the semi-visible watermark. The input corresponds to the semi visible watermark. The processing further includes processing the input to generate an input result. The subscriber information device stores subscriber identifiers and identifies a particular subscriber by comparing the input result and the subscriber identifiers.

According to an embodiment, a method identifies an unauthorized display of content. The method includes preprocessing the content for subsequent insertion of semi-visible information. The method further includes inserting a semi-visible watermark into the content as having been preprocessed. The semi-visible watermark corresponds to a subscriber identifier. The method further includes receiving an input from an observer that observes a display of the content that includes the semi-visible watermark. The input corresponds to the semi visible watermark. The method further includes processing the input to generate an input result. The method further includes identifying a particular subscriber by comparing the input result and a plurality of subscriber identifiers.

According to an embodiment, an apparatus includes a device for preprocessing content for subsequent insertion of semi-visible information. The device includes a receiver, a preprocessor, and a transmitter. The receiver receives the content. The preprocessor preprocesses the content according to a human visual system model for subsequent insertion of the semi-visible information, and generates preprocessed content. The transmitter transmits the preprocessed content for subsequent insertion of the semi-visible information.

According to an embodiment, an apparatus includes a device for inserting semi-visible information into preprocessed content. The device includes a receiver and an inserter. The receiver receives the preprocessed content. The preprocessed content has been preprocessed according to a human visual system model. The inserter inserts a semi-visible watermark into the preprocessed content and generates watermarked content. The semi-visible watermark corresponds to a subscriber identifier.

According to an embodiment, a system identifies an unauthorized display of content. The system comprises a preprocessor device, an inserter device, an observation device, and a subscriber information device. The preprocessor device preprocesses the content for subsequent insertion of semi-visible information. The inserter device inserts semi-visible watermarks into the content as having been preprocessed by the preprocessor device. Each semi-visible watermark denotes the value of one element of a set of elements, the set in aggregate constituting a unique identifier traceable to at least one of the inserter device and a responsible subscriber. The observation device executes processing, including receiving an input from an observer that observes a display of the content that includes the semi-visible watermarks. The input corresponds to the observed semi visible watermarks. The processing further includes processing the input to determine the unique identifier corresponding to the set of observed semi-visible watermarks. The subscriber information device stores a plurality of subscriber identifiers and that identifies a particular subscriber by comparing the unique identifier and the plurality of subscriber identifiers.

The following detailed description and accompanying drawings provide a better understanding of the nature and advantages of the present invention.

### BRIEF DESCRIPTION OF THE DRAWINGS

FIG. 1 is a block diagram of a content identification system according to an embodiment of the present invention.

FIG. 2 is a flow diagram of a method of identifying content according to an embodiment of the present invention.

FIG. 3 is a block diagram representing an exemplary computing device suitable for use in conjunction with implementing one or more of the processes or devices described above.

FIG. 4 is a block diagram of a cable headend that may be used to implement the preprocessor device and the transmitter device (see FIG. 1) according to an embodiment of the present invention.

FIG. 5 is a block diagram of a set top box that may be used to implement the receiver device and the inserter device (see FIG. 1) according to an embodiment of the present invention.

FIG. 6 is a block diagram of a mobile device that may be used to implement the observation device (see FIG. 1) according to an embodiment of the present invention.

### DETAILED DESCRIPTION

Described herein are techniques for identifying unauthorized content display. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In the following description, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In general, embodiments of the present invention relate to adding an identifying set of marks to video content that can be used to determine subscriber identifying information (e.g., set top box serial number, or account information). The mark may be semi-visible. A semi-visible mark would be visible to a trained observer, and a casual viewer would not necessarily notice the mark. Training would include ability to observe and recognize certain spatial and temporal characteristics used to mask or hide the mark. To recover the message from a set of marks for the semi-visible case an observer or inspector would watch the video for a period of time and record the marks and translate them via a computer program into the subscriber identifying information. The end use is to be able to tie a video back to a customer or set top box, and would be used in general to provide revenue protection for the video content owner. As an analogy, consider a car with a license plate: The car is the video and the license plate is the identifying information.

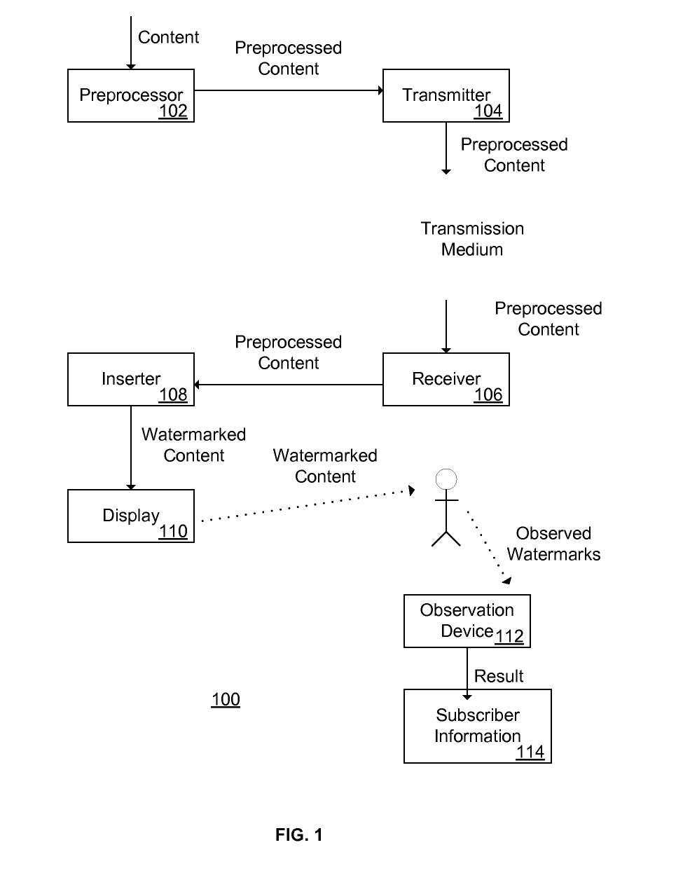

FIG. 1 is a block diagram of a content identification system 100 according to an embodiment of the present invention. The content identification system 100 includes a preprocessor device 102, a transmitter device 104, a receiver device 106, an inserter device 108, a display device 110, an observation device 112, and a subscriber information device 114. Two or more of these devices may be combined together as desired according to various embodiments. For example, the receiver device 106 and the inserter device 108 may be implemented together in a set top box. The observation device 112 and the subscriber information device 114 may be implemented together in a mobile telephone.

The preprocessor device 102 preprocesses the content for use with the rest of the content identification system 100. The preprocessor device 102 takes the content (input video data) and first determines where to place each watermarking symbol in the video. According to one embodiment, a Human Visual System (HVS) model may be used to determine the spatial and temporal locations of each symbol that will provide a good semi-visible characteristic depending on the type of symbol being processed. According to one embodiment, the preprocessor device 102 uses a Just Noticeable Difference (JND) model to modify the video in such a way that the semi-visible criteria is met. The preprocessor device 102 uses the JND model to modify the video signal to carry one portion of the message (e.g., a ‘0 ’ bit). The preprocessor device 102 creates a new piece of video, again using the JND model, which represents the other portion of the message (e.g., a ‘1 ’ bit). The new video data can be considered meta-data and is stored or packaged within the video. The preprocessor device 102 outputs the preprocessed content to the transmitter device 104.

As more fully detailed in subsequent sections, the message may be represented by different types of symbols. According to one embodiment, the symbols are “0” and “1” bits. According to one embodiment, the symbols are decimal digits. According to one embodiment, the symbols are in a language other than English.

The transmitter device 104 receives the preprocessed content from the preprocessor device 102 and transmits it to one or more subscribers. The specific implementation of the transmitter device 104 may vary depending upon the specifics of the content identification system 100. For example, in a satellite distribution context, the transmitter device 104 may be a component of a satellite uplink device, a satellite, or a satellite downlink device (in a situation where the satellite signal is further distributed). In a cable distribution context, the transmitter device 104 may be a component of a cable headend device. In a terrestrial broadcasting environment, the transmitter 104 may coupled to an over the air broadcast antenna or microwave antenna. In a computer network context, the transmitter 104 may be a component of a computing device such as a server. Furthermore, the content may be distributed in real time or asynchronously, for example, using “drip video on demand”, where the content is slowly distributed for subsequent playback.

The receiver device 106 receives the transmission from the transmitter device 104. The transmission may be made via a medium such as the airwaves (for a satellite transmission or terrestrial broadcast transmission) or a coaxial cable (for a cable system). In general, the receiver device 106 is associated with a specific subscriber (also referred to as a customer). For example, in a satellite distribution context, the receiver device 106 includes a satellite dish and a set top box for processing satellite signals. In a cable distribution context, the receiver device 106 includes a set top box for processing cable signals. The receiver device 106 may also be a component of a television or a computing device (for example, a computer program that manages the reception). The receiver device 106 may perform other functions of a set top box, such as decoding, descrambling, recording, time shifting, etc.

The inserter device 108 inserts a semi-visible watermark into the preprocessed content received by the receiver 106. The semi-visible watermark corresponds to a subscriber identifier that identifies the subscriber that has been authorized to display that content. The inserter device 108 may also make the semi-visible watermark more robust by adding error correction information to the subscriber identifier. The inserter device 108 inserts the semi-visible watermark into the video by adding the ‘0 ’ or ‘1 ’ bit (or other symbols, as discussed) as required. The inserter device 108 outputs the watermarked content to the display device 110.

The display device 110 receives the watermarked content from the inserter device 108 and displays the watermarked content. The display device 110 in general corresponds to a television. In general, the display device 110 may be in a location accessible to the public, for example, in a bar or pub.

An observer may then view the content in order to determine whether the display has been authorized. The observer observes the semi-visible watermarks and inputs them into the observation device 112.

The observation device 112 assists the observer to record the semi-visible watermarks that the observer has observed. In general, the observation device 112 converts the ‘0 ’ and ‘1 ’ bits into an input result that corresponds to the customer identifying information. The observation device 112 may perform error correction on the bits to fix any errors, and then it converts the bits into the input result. According to one embodiment, multiple transmissions of the same message may be made for error correction purposes. For example, if two input sequences are 12445 and 12355, then the observation device 112 can detect that the first, second and fifth characters may be correct, and that the third and fourth characters may be erroneous. In the example given above for a pub application where semi-visible marks are added to the video, the recovery program instructions may reside on an inspector's mobile telephone. The inspector would recognize the synchronization signals and then type in the series of symbols displayed in the video into the cell phone application. When the inspector recognizes the end of sequence symbol, the inspector would hit enter on the cell phone, the observation device 112 applies error correction to the bits, and then the result representing the customer identifying information would be displayed.

The subscriber information device 114 receives the input result from the observation device 112 and compares the input result to information it has stored regarding the customers for the content. For example, the subscriber information device 114 may include a computing device that receives the input result from the observation device 112. The computing device may include a database of subscriber information, and may include program instructions to perform a lookup using the input result. Since the input result was inserted by the inserter 106, which is part of a device that is associated with a particular customer, that information may be stored as part of the subscriber information. Thus, as a result of the observed watermarks, the authorized subscriber for the content may be identified. If the observer is observing the content in a location other than that of the authorized subscriber, then the display is unauthorized.

As discussed above, a mobile device embodiment may include the observation device 112 and the subscriber information device 114. The subscriber information device 114 then may include a database of subscriber identifiers and program instructions that look up the specific subscriber information from the database using the input result. Furthermore, this application may be tied to or communicate with the content owners to determine if the device is for a commercial or residential account. Because this could happen in near real-time, the inspector could take immediate action. The application could also be tied to or communicate with the content owners to have the offending device (receiver device 106, display device 110, etc.) disabled.

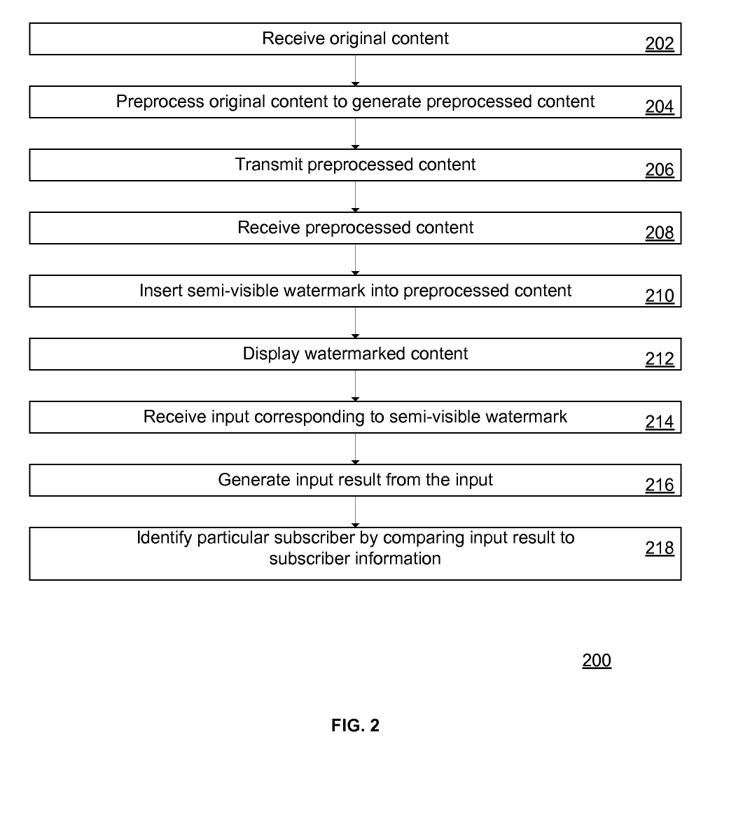

FIG. 2 is a flow diagram of a method 200 of identifying content according to an embodiment of the present invention. The method 200 may be performed by devices such as those described regarding the content identification system 100 (see FIG. 1).

In step 202, the original content is received. The content may be video content, audiovisual content, etc. A device such as the preprocessor device 102 (see FIG. 1) may receive the content.

In step 204, the original content is preprocessed to generate preprocessed content. In general, the preprocessing modifies the content for subsequent insertion of semi-visible watermarks. A device such as the preprocessor 102 (see FIG. 1) may generate the preprocessed content.

In step 206, the preprocessed content is transmitted. The transmission may occur via a satellite transmission, a cable transmission, etc. Note that the preprocessed content may be received by one or more subscribers of the content. A device such as the transmitter device 104 (see FIG. 1) may transmit the preprocessed content.

In step 208, the preprocessed content is received. In general, the content is received by an authorized subscriber for display at the subscriber location (see step 212 below). A device such as the receiver device 106 (see FIG. 1) may receive the preprocessed content.

In step 210, a semi-visible watermark is inserted into the preprocessed content. In general, the semi-visible watermark corresponds to the authorized subscriber (see step 208). A device such as the inserter device 108 (see FIG. 1) may insert the semi-visible watermark into the preprocessed content.

In step 212, the watermarked content is displayed. In general, the semi-visible watermark can be used to identify the authorized subscriber without excessively detracting from display of the content. A device such as the display device 110 (see FIG. 1) may display the watermarked content.

In step 214, an input corresponding to the semi-visible watermark is received. In general, an observer perceives the semi-visible watermark when the watermarked content is displayed, and enters the input into an observation device such as the observation device 112 (see FIG. 1). The observation device may execute program instructions to prompt for entry of the input, to receive the input, to store the input, etc.

In step 216, an input result is generated from the input. The process for generating the input may include one or more substeps. One substep is to perform error correction on the input. Another substep is to convert visual representations of the watermarks (e.g., “/” and “\”) into binary information (e.g., “0” and “1”). Another substep is to convert binary information into decimal or alphanumeric information in the format of a subscriber account number. Thus, the input result corresponds to the watermark inserted in step 210. A device such as the observation device 112 (see FIG. 1) may generate the input result from the input.

In step 218, a particular subscriber is identified by comparing the input result (see step 216) with subscriber information. The subscriber information may be a list, set, subset, or database of all the authorized subscribers for the content. Since in step 210 the watermark corresponds to the subscriber, and in step 216 the input result corresponds to the watermark, in step 218 the particular subscriber may be identified from the list of subscribers. A device such as the subscriber information device 114 (see FIG. 1) may identify the particular subscriber from the input result.

In this manner, at a particular location that is displaying content, the authorized subscriber of that content can be determined. Returning to the pub example above, if the pub is displaying content that was authorized only for non-commercial (home) use, the particular subscriber information for the content may be identified. Then the subscriber may be contacted to purchase a commercial license, the authorization of that subscriber may be revoked, etc.

### Examples and Additional Embodiments

In addition to the embodiments described above, further embodiments may include one or more of the following features.

In one example implementation, a series of symbols is placed in the video over a period of time to provide a semi-visible mark. For example in this implementation each symbol is displayed every 2 seconds of time. Each symbol represents a single bit of the message, and a set of symbols represents a unique message. For example a dash can represent a ‘0 ’ bit and a vertical line can represent a ‘1 ’ bit. (Alternatively, each symbol may represent multiple bits; for example, eight symbols may represent three bits of information.) There is a start of message sequence to identify to an inspector the start of the message. In this implementation the start of message sequence is the display of two ‘/’ symbols. Following the start of message sequence a number of dashes and vertical lines will be displayed to represent each bit of the message. To prevent errors, an error correction algorithm may also be applied to the message. Following the complete message an end of sequence indication ‘/’ is displayed.

Preprocessing

As discussed above, a HVS model may be used when preprocessing the content. The parameters of the content that may be adjusted include performing low pass filtering, reducing the color resolution, reducing motion that is outside peripheral vision, reducing color resolution in the presence of brightness information, reducing textural resolution in the presence of motion information, reducing depth resolution in the presence of textural information, and reducing depth resolution in the presence of facial information. Further parameters that may be adjusted include reducing the resolution of textural areas, reducing the luminance information, and performing temporal masking.

According to an embodiment, the number of frames used to display the mark may be increased. For example, the mark may be displayed in two consecutive frames, which increases the amount of time for the observer to detect the mark.

Semi-Visible Marks

The semi-visible marks suitable according to an embodiment of the present invention may be selected according to desirable locations in the content. That is, with the knowledge that some locations in content are more desirable than others for semi-visible marks, the semi-visible marks may be selected to fit well in those locations. One such location is where the content contains a large amount of texture (for example, in images of trees), since human perception is less likely to identify a symbol from the “noise” provided by the texture. Other examples of suitable locations include medium luminance areas, and areas with objects that are similar to a mark (for example, when the symbol is a vertical line, an area that includes a vertical object, etc.). Temporal locations may also be used. For example, the marks may be placed right before or right after a scene change, because a casual observer is less likely to notice the mark due to all the other parts of the content that are changing in the scene change.

Backchannel

A backchannel may be used for communication between the observation device 112 and the inserter 108. For example, a mobile telephone may include program instructions for the observer to activate and deactivate the insertion of watermarks.

The observer can use the backchannel to turn on marking when they are at a suspect premise and to turn it off when they are done with the inspection. This could also be used to turn marking on or off during certain times of day when inspectors are active or for example to turn it off during prime time viewing. One method to implement this feature is to have the transmitter device 104 send a signal to the inserter device 108 to turn the watermark on or off. This signal could be sent through the Conditional Access (CA) system or via an entitlement control message (ECM). The inserter device 108 would recognize this signal and turn the marking on or off as appropriate.

Another method to turn marking on or off is for the video content owner to turn it off at the preprocessor device 102. In this case, the inserter device 108 uses the original content (not the preprocessed content) and sees no opportunities to insert the watermarks.

Inserter Device

As discussed above, the inserter device 108 may be implemented as part of the customer's set top box. According to another embodiment, the inserter device 108 can reside at any location or within any equipment that knows the customer identifying information and has access to the video. One such location for the inserter device 108 is within the device that implements the preprocessor device 102. According to an embodiment, a content server or video on demand system includes the inserter device 108. These devices unicast to a customer and thus are aware of the subscriber information.

Location Adjustment

The preprocessor device 102 may implement one or more placement options when preprocessing the content for subsequent insertion of the semi-visible watermarks. One option is insertion at a single location. Such placement allows the observer to concentrate on a particular area to perceive the semi-visible watermarks. Another option is insertion at a sequence of locations. Such placement allows the observer to concentrate on successive areas to perceive the semi-visible watermarks. Another option is insertion at a random sequence of locations. Another option is insertion at a sequence of locations as determined by the HVS model to reduce perceptibility of the symbol from casual observation (i.e., by other than the observer). One advantage of moving the symbols around on the video is that this reduces the counter measure of blacking out the message area by the unauthorized subscriber. According to an embodiment, the location of the mark may be changed, either sequentially or randomly, after the display of one complete message.

Symbol Adjustment

As discussed above, two symbols such as a dash and vertical line may be used to represent one bit of information (e.g., “1” and “0”). However, multiple symbols may be used to display more than one piece of information. According to one embodiment, four symbols may be used to represent two bits of information (e.g., “00”, “01”, “10” and “11”). As an example of four such symbols, consider “/”, “\”, “-” and “|”. According to another embodiment, eight symbols may be used to represent three bits of information (e.g., “000”, “001”, “010”, “011”, “100”, “101”, “110” and “111”). As an example of eight such symbols, consider “┌”, “┐”, “└”, “┘”, “├”, “┤”, “T”, and “⊥”). One advantage of using more symbols is that a message can be represented in a shorter amount of time.

According to another embodiment, multiple symbols may be used to distinguish portions of the message. For example during the first half of the message one set of symbols may be used, and during the second half of the message a different set of symbols can be used. (That is, the first set of symbols have a first format and the second set of symbols have a second format.) One advantage of this method is that the different symbols allow the recovery error correction logic to be more accurate.

As discussed above, multiple symbols may be used to denote more information or to denote which portion of a message is being displayed. According to another embodiment, other characteristics of the symbol may be used to denote more or different information. For example, the color, shape, or size of the symbol may be adjusted to increase the amount of information conveyed by the symbol. As another example, different areas of the screen may be used to convey more information (e.g., the first half of message is displayed on the left half of the screen and the second half of the message is displayed on the right).

According to another embodiment, the symbol can be placed in a particular spatial or temporal location. An example of a spatial location is one where the video content owner displays their logo (e.g., a symbol could always be placed in the ‘ABC’ logo). An example of temporal location could be during a commercial or other period of time controlled by the video provider. An advantage of placing the symbol according to spatial or temporal factors is that these factors may be selected such that patrons are paying less attention to the display (and hence less likely to perceive the watermarks).

According to another embodiment, the symbol can be coordinated with a given characteristic of the video. For example if the ‘ABC’ logo was displayed on the video, the symbol could turn the ‘B’ in ‘ABC’ to red for a ‘0 ’ bit and blue for a ‘1 ’ bit. Other combinations of shape, size, color and position can be used to modify a given video area. An example of position could be to move the ‘B’ in ‘ABC’ a little higher for one of the bits and a little lower for the other bit.

According to another embodiment, the symbols used may change over time. For example, after an amount of time (or after a defined number of messages have been displayed) a new symbol set may be used. This new symbol set may use a different size, shape, or color to represent the symbols. The mark changing over time can be controlled in the preprocessor device 102 and can be used to obfuscate the technique or may be used if a counter measure is found to a particular technique. In such an embodiment, the inserter device 108 need not even be aware that the symbols are changing.

According to another embodiment, multiple symbols may be placed in each frame. That is, instead of a single symbol being inserted at a time, two or more symbols are inserted for display at the same time. For example, one symbol may be placed in one area of the display, and a second symbol may be placed in another area of the display.

As described above, the marking may be turned on or off in the preprocessor device 102. According to another embodiment, the preprocessor device 102 may also control other characteristics of the mark. For example, size, color and mark strength (i.e., visibility) can all be controlled in real-time at the preprocessor device 102. In addition, the preprocessor device 102 may also control the temporal aspects of the mark insertion, for example turned on during the first half of a sporting event and turned off for the remainder.

Error Correction

According to another embodiment, to aid in error correction, the preprocessor device 102 may add synchronization marks. These marks aid in the error correction of missing bits. Furthermore, these synchronization marks are not limited to just symbols, but many of the other variable characteristics described above (e.g., color, shape, size, position, etc.) may also be used to represent the synchronization marks.

According to another embodiment, the inserter 108 may insert the semi-visible watermarks using an error correction process to represent the information conveyed by the watermarks. The error correction process increases the robustness and confidence level when multiple copies of the message are available. According to an embodiment, the error correction process includes using a checksum. According to an embodiment, the error correction process includes a Reed-Solomon code.

Audio Signal

According to another embodiment, audio information may be used to represent one or more of the features described above (such as additional information for a symbol, for synchronization information, etc.). As an example, an audio symbol may be used as the synchronization symbol or to distinguish portions for the message.

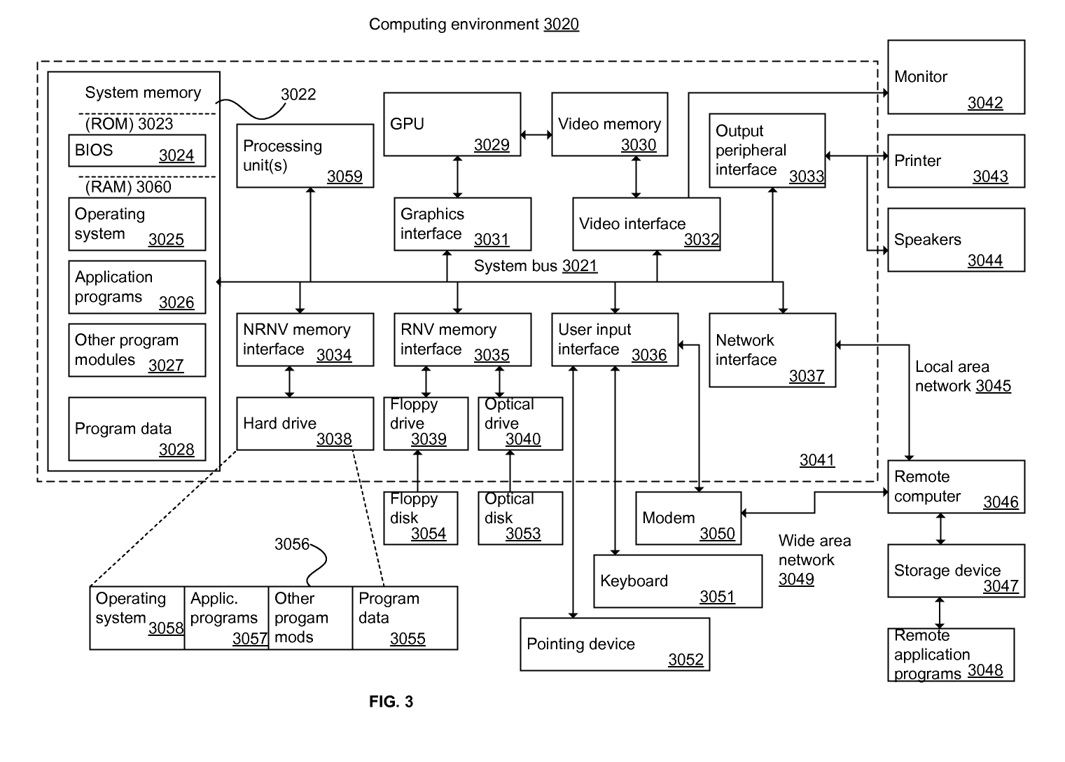

FIG. 3 is a block diagram representing an exemplary computing device 3020 suitable for use in conjunction with implementing one or more of the processes or devices described above. For example, the computer executable instructions that carry out the processes and methods corresponding to the preprocessor device 102 may reside and/or be executed in such a computing environment as shown in FIG. 3. As another example, a set top box implementing the receiver device 106 and the inserter device 108 may include one or more components of the computing environment as shown in FIG. 3. As a further example, the subscriber information device 114 may include one or more components of the computing environment as shown in FIG. 3.

The computing system environment 3020 is only one example of a suitable computing environment and is not intended to suggest any limitation as to the scope of use or functionality of the invention. Neither should the computing environment 3020 be interpreted as having any dependency or requirement relating to any one or combination of components illustrated in the exemplary operating environment 3020.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer 3041. Components of computer 3041 may include, but are not limited to, a processing unit 3059, a system memory 3022, and a system bus 3021 that couples various system components including the system memory to the processing unit 3059. The system bus 3021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 3041 typically includes a variety of computer readable media. Computer readable media can be any available media that can be accessed by computer 3041 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 3041. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media (but not necessarily computer readable storage media; for example, a data signal that is not stored).

The system memory 3022 includes computer storage media in the form of volatile and/or nonvolatile memory such as read only memory (ROM) 3023 and random access memory (RAM) 3060. A basic input/output system 3024 (BIOS), containing the basic routines that help to transfer information between elements within computer 3041, such as during start-up, is typically stored in ROM 3023. RAM 3060 typically contains data and/or program modules that are immediately accessible to and/or presently being operated on by processing unit 3059. By way of example, and not limitation, FIG. 3 illustrates operating system 3025, application programs 3026, other program modules 3027, and program data 3028.

The computer 3041 may also include other removable/non-removable, volatile/nonvolatile computer storage media. By way of example only, FIG. 3 illustrates a hard disk drive 3038 that reads from or writes to non-removable, nonvolatile magnetic media, a magnetic disk drive 3039 that reads from or writes to a removable, nonvolatile magnetic disk 3054, and an optical disk drive 3040 that reads from or writes to a removable, nonvolatile optical disk 3053 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 3038 is typically connected to the system bus 3021 through an non-removable memory interface such as interface 3034, and magnetic disk drive 3039 and optical disk drive 3040 are typically connected to the system bus 3021 by a removable memory interface, such as interface 3035.

The drives and their associated computer storage media discussed above and illustrated in FIG. 3, provide storage of computer readable instructions, data structures, program modules and other data for the computer 3041. In FIG. 3, for example, hard disk drive 3038 is illustrated as storing operating system 3058, application programs 3057, other program modules 3056, and program data 3055. Note that these components can either be the same as or different from operating system 3025, application programs 3026, other program modules 3027, and program data 3028. Operating system 3058, application programs 3057, other program modules 3056, and program data 3055 are given different numbers here to illustrate that, at a minimum, they are different copies. A user may enter commands and information into the computer 3041 through input devices such as a keyboard 3051 and pointing device 3052, commonly referred to as a mouse, trackball or touch pad. Other input devices (not shown) may include a microphone, joystick, game pad, satellite dish, scanner, or the like. These and other input devices are often connected to the processing unit 3059 through a user input interface 3036 that is coupled to the system bus, but may be connected by other interface and bus structures, such as a parallel port, game port or a universal serial bus (USB). A monitor 3042 or other type of display device is also connected to the system bus 3021 via an interface, such as a video interface 3032. For complex graphics, the computer 3041 may offload graphics processing through the graphics interface 3031 for processing by the graphics processing unit 3029. The graphics rendered by the graphics processing unit 3029 may be stored in the video memory 3030 and provided to the video interface 3032. In addition to the monitor, computers may also include other peripheral output devices such as speakers 3044 and printer 3043, which may be connected through a output peripheral interface 3033.

The computer 3041 may operate in a networked environment using logical connections to one or more remote computers, such as a remote computer 3046. The remote computer 3046 may be a personal computer, a server, a router, a network PC, a peer device or other common network node, and typically includes many or all of the elements described above relative to the computer 3041, although only a memory storage device 3047 has been illustrated in FIG. 3. The logical connections depicted in FIG. 3 include a local area network (LAN) 3045 and a wide area network (WAN) 3049, but may also include other networks. Such networking environments are commonplace in offices, enterprise-wide computer networks, intranets and the Internet.

When used in a LAN networking environment, the computer 3041 is connected to the LAN 3045 through a network interface or adapter 3037. When used in a WAN networking environment, the computer 3041 typically includes a modem 3050 or other means for establishing communications over the WAN 3049, such as the Internet. The modem 3050, which may be internal or external, may be connected to the system bus 3021 via the user input interface 3036, or other appropriate mechanism. In a networked environment, program modules depicted relative to the computer 3041, or portions thereof, may be stored in the remote memory storage device. By way of example, and not limitation, FIG. 3 illustrates remote application programs 3048 as residing on memory device 3047. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

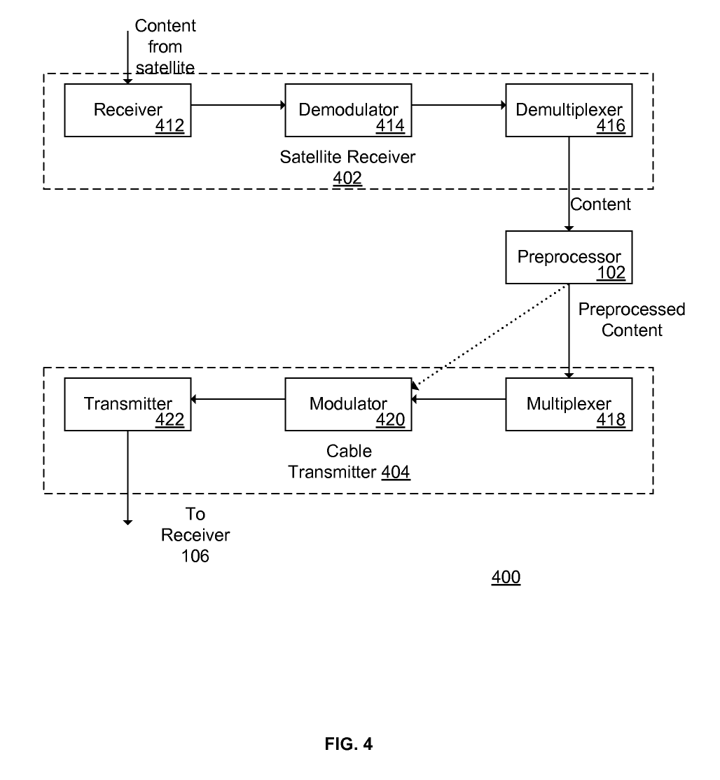

FIG. 4 is a block diagram of a cable headend 400 that may be used to implement the preprocessor device 102 and the transmitter device 104 (see FIG. 1) according to an embodiment of the present invention. The cable headend 400 includes a satellite receiver 402, the preprocessor device 102, and a cable transmitter 404. Additional components unrelated to embodiments of the invention, such as power supplies, etc. are omitted for brevity.

The satellite receiver 402 prepares the content for preprocessing by the preprocessor device 102. The satellite receiver 402 includes a receiver 412, a demodulator 414, and a demultiplexer 416.

The receiver 412 receives content that is distributed to the cable headend 400 from a satellite. According to another embodiment, the content may be received from other sources, such as a microwave link, a telecommunications link such as a T-1 or T-3 or OC-3 line, or a data link such as the internet, with appropriate adjustments to the devices implementing the receiver 412.

The demodulator 414 demodulates the signal received by the receiver 412 and outputs a demodulated signal to the demultiplexer 416. The demodulator 414 may be omitted in an embodiment that receives an unmodulated signal.

The demultiplexer 416 demultiplexes the demodulated signal from the demodulator 414 and outputs the content to the preprocessor 102. The demultiplexer 416 may be omitted in an embodiment that receives an unmultiplexed signal.

The preprocessor device 102 receives the content and generates the preprocessed content as described above regarding FIG. 1. The preprocessor device 102 may be implemented by the computing environment such as described above in FIG. 3. According to an embodiment, the preprocessor 102 provides the preprocessed content to the multiplexer 418. This embodiment uses the solid line to show that the content is multiplexed. According to an embodiment, the preprocessor 102 provides the preprocessed content to the modulator 420. This embodiment uses the dashed line to show that the content is not multiplexed.

The cable transmitter 404 prepares the preprocessed content for transmission to the receiver 106 (see FIG. 1). The cable transmitter 404 includes a multiplexer 418, a modulator 420, and a transmitter 422.

The multiplexer 418 receives the preprocessed content from the preprocessor device 102 and generates multiplexed content to the modulator 420. The modulator 420 receives the multiplexed content from the multiplexer 418 and generates modulated content to the transmitter 422. The transmitter 422 receives the modulated content from the modulator 420 and transmits the preprocessed content into a transmission medium (here, a cable distribution system) for reception by the receiver device 106 (see FIG. 1).

Additional components may be added to the cable headend 400 as desired. For example, if the signals from the satellite are encrypted, a decoder device may be added to the satellite receiver 402. If it is desired to encode the signals sent to the receiver device 106, an encoder device may be added to the cable transmitter 404.

Although the embodiment of FIG. 4 is directed toward a cable distribution system, similar components may be used and modified as needed for other distribution systems, such as a satellite distribution system.

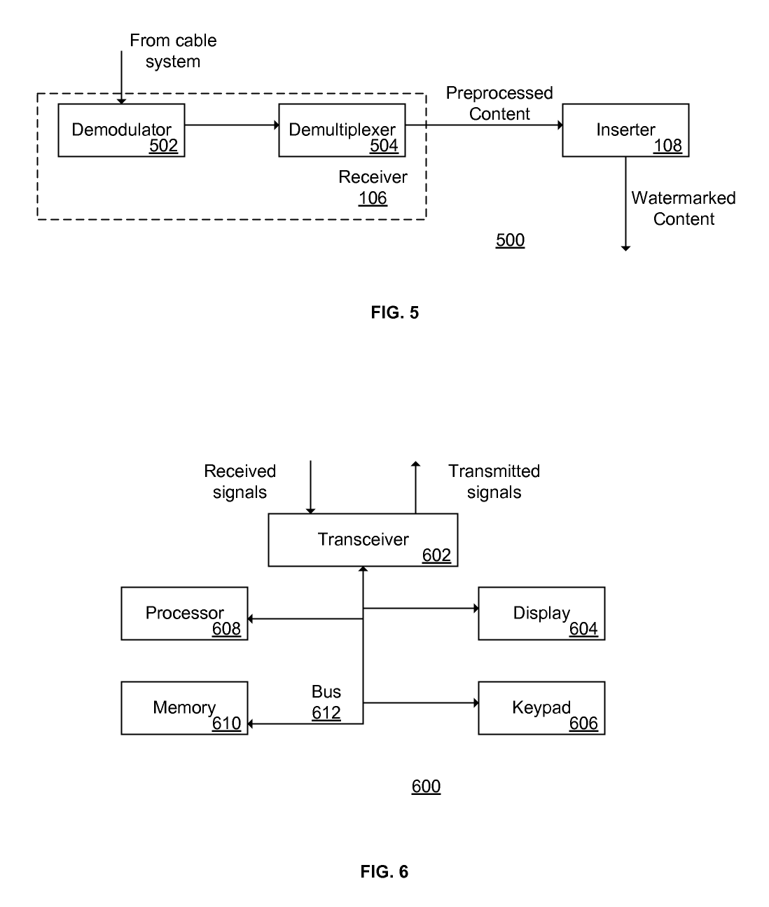

FIG. 5 is a block diagram of a set top box 500 that may be used to implement the receiver device 106 and the inserter device 108 (see FIG. 1) according to an embodiment of the present invention. The set top box 500 includes a demodulator 502 and a demultiplexer 504.

The demodulator 502 demodulates the signal received from the cable network from the cable transmitter 404 (see FIG. 4). The demodulator 502 may be omitted in an embodiment that receives an unmodulated signal.

The demultiplexer 504 demultiplexes the demodulated signal from the demodulator 502 and outputs the preprocessed content to the inserter device 108. The demultiplexer 416 may be omitted in an embodiment that receives an unmultiplexed signal.

The inserter device 108 operates as described above. The inserter device 108 may be implemented by components similar to some of the components described in the computing environment of FIG. 3.

FIG. 6 is a block diagram of a mobile device 600 that may be used to implement the observation device 112 (see FIG. 1) according to an embodiment of the present invention. The mobile device 600 includes a transceiver 602, a display 604, a keypad 606, a processor 608, a memory 610, and a bus 612. Various other components such as a power supply, speaker, microphone, etc. that are unrelated to aspects of the present invention are omitted for brevity. In general, the mobile device 600 may be implemented to include one or more of the components described above regarding the computing environment of FIG. 3.

The transceiver 602 receives signals from a wireless communications network, and transmits signals to the wireless communications network. The specific implementation of the transceiver 602 may vary depending upon the specific type of wireless communications network. When the subscriber information device 114 (see FIG. 1) is located on a remote computer, the transceiver 602 transmits the result of the watermark entry to the subscriber information device 114, and may receive back further information or instructions for the observer. For example, the subscriber information device 114 may send back the address associated with the customer information corresponding to the watermark entry, so that the observer can verify that the address is the authorized address.

According to another embodiment, the transceiver 602 can communicate with the preprocessor 102 (see FIG. 1) to start or stop preprocessing the content.

The display 604 displays various information related to the mobile device 600. In the context of embodiments of the present invention, the display 604 may display the watermark entered by the observer into the mobile device 600, so that the observer can verify that it was accurately entered.

The keypad 606 allows for data entry into the mobile device 600. The keypad 606 can be a conventional mobile telephone keypad, an enhanced mobile telephone keypad (e.g., personal digital assistant, Sidekick™, Blackberry™, etc.), or a touch pad that is integrated with the display 604 (e.g., iPhone™, etc.). The observer may enter the observed watermarks into the mobile device 600 using the keypad 606.

The processor 608 controls the operation of the mobile device 600. In the context of embodiments of the present invention, the processor 608 executes processing instructions related to the tasks the observer performs when observing the watermarks. This processing may include prompting for data entry, receiving entered data, performing error correction, translating the watermarks into a customer identifier, etc. The processing may be implemented in accordance with the operating system of the mobile device 600, including Windows Mobile™, Symbian™ Andriod™, Palm™, iPhone™, etc.

The memory 610 stores data used in the operation of the mobile device 600. In the context of embodiments of the present invention, the memory 608 stores the processing instructions used by the processor 608, stores data related to translating watermarks into customer identifiers, etc.

According to another embodiment, the mobile device 600 also implements the subscriber information device 114. In such an embodiment, the memory 610 stores the subscriber information that the mobile device 600 would otherwise access from the subscriber information device 114 (see FIG. 1). In an embodiment where the mobile device 600 implements the subscriber information device 114, the transceiver 602 may be omitted.

Further Implementation Details

The invention may be implemented in hardware, executable modules stored on a computer readable medium, or a combination of both (e.g., programmable logic arrays). Unless otherwise specified, the steps included as part of the invention are not inherently related to any particular computer or other apparatus. In particular, various general-purpose machines may be used with programs written in accordance with the teachings herein, or it may be more convenient to construct more specialized apparatus (e.g., integrated circuits) to perform the required method steps. Thus, the invention may be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein. (Software per se and intangible signals are excluded to the extent that they are unpatentable subject matter.)

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A system for identifying an unauthorized display of content, comprising:
a preprocessor device that preprocesses the content for subsequent insertion of semi-visible information;
an inserter device that inserts a semi-visible watermark into the content as having been preprocessed by the preprocessor device, wherein the semi-visible watermark corresponds to a subscriber identifier;
an observation device that executes processing comprising:
receiving an input from an observer that observes a display of the content that includes the semi-visible watermark, wherein the input corresponds to the semi-visible watermark, and
processing the input to generate an input result; and
a subscriber information device that stores a plurality of subscriber identifiers and that identifies a particular subscriber by comparing the input result and the plurality of subscriber identifiers.

2. The system of claim 1, wherein the preprocessor device preprocesses the content according to a human visual system model.

3. The system of claim 1, wherein the preprocessor device preprocesses the content according to a just noticeable difference model.

4. The system of claim 1, wherein the inserter device generates the semi-visible watermark as a result of applying error correction to the subscriber identifier.

5. The system of claim 1, wherein the inserter device includes a start of sequence indication in the semi-visible watermark.

6. The system of claim 1, wherein the observation device communicates with the inserter device to stop inserting the semi-visible watermark.

7. The system of claim 1, wherein the observation device communicates with the preprocessor device to stop preprocessing the content.

8. The system of claim 1, wherein the semi-visible watermark corresponds to at least two watermarks that are inserted to be displayed at two different locations in the content.

9. The system of claim 1, wherein the semi-visible watermark corresponds to a symbol representing more than one bit of information.

10. The system of claim 1, wherein the semi-visible watermark corresponds to a first set of symbols and a second set of symbols, wherein a format of the second set differs from that of the first set.

11. The system of claim 1, wherein the semi-visible watermark corresponds to color information of a symbol.

12. The system of claim 1, wherein the semi-visible watermark corresponds to shape information of a symbol.

13. The system of claim 1, wherein the semi-visible watermark corresponds to size information of a symbol.

14. The system of claim 1, wherein the semi-visible watermark corresponds to location information of a symbol.

15. The system of claim 1, wherein the semi-visible watermark corresponds to audio information of a symbol.

16. The system of claim 1, wherein the semi-visible watermark comprises a plurality of semi-visible watermarks.

17. The system of claim 1, wherein the semi-visible watermark comprises a plurality of semi-visible watermarks, and wherein the inserter device inserts the plurality of semi-visible watermarks sequentially.

18. A method of identifying an unauthorized display of content, comprising:
preprocessing the content for subsequent insertion of semi-visible information;
inserting a semi-visible watermark into the content as having been preprocessed, wherein the semi-visible watermark corresponds to a subscriber identifier;
receiving an input from an observer that observes a display of the content that includes the semi-visible watermark, wherein the input corresponds to the semi visible watermark;
processing the input to generate an input result; and
identifying a particular subscriber by comparing the input result and a plurality of subscriber identifiers.

19. The method of claim 18, wherein the preprocessing comprises:
preprocessing the content according to a human visual system model.

20. The method of claim 18, wherein the preprocessing comprises:
preprocessing the content according to a just noticeable difference model.

21. An apparatus including a device for preprocessing content for subsequent insertion of semi-visible information, comprising:
a receiver device that receives the content;
a preprocessor device that preprocesses the content according to a human visual system model for subsequent insertion of the semi-visible information, and that generates preprocessed content; and
a transmitter device that transmits the preprocessed content for subsequent insertion of the semi-visible information.

22. An apparatus including a device for inserting semi-visible information into preprocessed content, comprising:
a receiver device that receives the preprocessed content, wherein the preprocessed content has been preprocessed according to a human visual system model; and
an inserter device that inserts a semi-visible watermark into the preprocessed content, wherein the semi-visible watermark corresponds to a subscriber identifier, and that generates watermarked content.

23. A system for identifying an unauthorized display of content, comprising:
a preprocessor device that preprocesses the content for subsequent insertion of semi-visible information;
an inserter device that inserts semi-visible watermarks into the content as having been preprocessed by the preprocessor device, wherein each semi-visible watermark denotes the value of one element of a set of elements, the set in aggregate constituting a unique identifier traceable to at least one of the inserter device and a responsible subscriber;
an observation device that executes processing comprising:
receiving an input from an observer that observes a display of the content that includes the semi-visible watermarks, wherein the input corresponds to the observed semi-visible watermarks, and
processing the input to determine the unique identifier corresponding to the set of observed semi-visible watermarks; and
a subscriber information device that stores a plurality of subscriber identifiers and that identifies a particular subscriber by comparing the unique identifier and the plurality of subscriber identifiers.

24. The system of claim 23, wherein the preprocessor utilizes a human visual system model to influence the selection of watermark locations in the content.

25. The system of claim 23, wherein the preprocessor utilizes a human visual system model to influence characteristics of individual watermarks that include at least one of intensity, color, orientation, pattern, and size.

26. The system of claim 25, wherein the human visual system model is a just noticeable difference model.

27. The system of claim 23, wherein the inserter device utilizes an error control coding algorithm to introduce redundancy into the set of elements corresponding to the unique identifier.

28. The system of claim 23, wherein the inserter device includes at least one semi-visible alignment watermark for the purpose of identifying the position of temporally proximate semi-visible watermarks in a sequence.

29. The system of claim 28, wherein the semi-visible alignment watermark is a start-of-sequence indicator.

30. The system of claim 28, wherein several semi-visible alignment watermarks are included at pre-determined locations for the purpose of detecting failures to observe temporally proximate semi-visible watermarks.

31. The system of claim 23, wherein the observation device communicates with the inserter device to start of stop inserting the semi-visible watermark.

32. The system of claim 23, wherein the observation device communicates with the preprocessor device to start or stop preprocessing the content.

33. The system of claim 23, wherein the semi-visible watermark corresponds to at least two watermarks that are inserted to be displayed at two different locations in the content.

34. The system of claim 23, wherein the element represented by the semi-visible watermark represents a single bit of information in a bit stream that communicates the unique identifier.

35. The system of claim 23, wherein the semi-visible watermark is selected from one of at least two distinct sets of symbols, according to the position of the semi-visible watermark in the sequence of semi-visible watermarks representing the unique identifier.

36. The system of claim 23, wherein the semi-visible watermark is distinguished in whole or in part by the color information of a symbol.

37. The system of claim 23, wherein the semi-visible watermark is distinguished in whole or in part by the shape information of a symbol.

38. The system of claim 23, wherein the semi-visible watermark is distinguished in whole or in part by the size information of a symbol.

39. The system of claim 23, wherein the semi-visible watermark is distinguished in whole or in part by the location information of a symbol.

40. The system of claim 23, wherein the semi-visible watermark is distinguished in whole or in part by the audio information of a symbol.
